(19) United States
(12) Patent Application Publication
(10) Pub. No.: US 2015/0332169 A1
(43) Pub. Date: Nov. 19, 2015

(54) INTRODUCING USER TRUSTWORTHINESS IN IMPLICIT FEEDBACK BASED SEARCH RESULT RANKING

(71) Applicant: International Business Machines Corporation, Armonk, NY (US)

(72) Inventors: John A. Bivens, Ossining, NY (US); Yu Deng, Yorktown Heights, NY (US); Peter X. O'Bryan, Pittsboro, NC (US); Jonathan J. Puryear, Raleigh, NC (US); Harigovind V. Ramasamy, Ossining, NY (US); Soumitra Sarkar, Cary, NC (US); Zaman Valli-Hasham, North Vancouver (CA); Kevin D. Wahlmeier, Raleigh, NC (US); Yinan Zhang, Urbana, IL (US)

(73) Assignee: International Business Machines Corporation, Armonk, NY (US)

(21) Appl. No.: 14/278,754

(22) Filed: May 15, 2014

(51) Int. Cl. G06N 99/00

(52) U.S. Cl. CPC G06N 99/005

(57) ABSTRACT

User trustworthiness may be introduced in implicit feedback based supervised machine learning systems. A set of training data examples may be scored based on the trustworthiness of users associated respectively with the training data examples. The training data examples may be sampled into a plurality of training data sets based on a weighted bootstrap sampling technique, where each weight is a probability proportional to trustworthiness score associated with an example. A machine learning algorithm takes the plurality of the training data sets as input and generates a plurality of trained models. Outputs from the plurality of trained models may be ensembled by computing a weighted average of the outputs of the plurality of trained models.

### FIELD

The present application relates generally to computers, and computer applications, machine learning, and more particularly to introducing user trustworthiness in machine learning techniques.

### BACKGROUND

Ranking quality of a search engine assures that the most relevant results are presented to its users. To improve the ranking of search results, search engines collect explicit or implicit feedback from users to train their ranking algorithms. In such a training process, a common assumption is that all of the users are reliable and their feedback is equally important. However in practice, that assumption may not be accurate. For instance, some users have more experience or insights than the others, which leads to the variation in reliability of their feedback.

Similarly, machine learning techniques may assume all labels are equally reliable. In supervised machine learning, for example, it is assumed that labeled data is always generated by an expert. In implicit feedback applied to Internet search, end user trustworthiness data is normally unavailable.

### BRIEF SUMMARY

A method of introducing user trustworthiness in implicit feedback based machine learning, in one aspect, may comprise obtaining training data examples. Each of the training data examples may be given a trustworthiness score based on trustworthiness of a user associated with the respective training data example. The method may also comprise sampling the training data examples into a plurality of samples based on a weighted bootstrap sampling technique that samples the training data examples with probability proportional to associated trustworthiness scores. A sample comprises one or more of the training examples. The method may further comprise running a supervised machine learning algorithm with the samples as input training data. The supervised machine learning algorithm generates a trained model corresponding to each of the plurality of samples, wherein a plurality of trained models is produced. The method may also comprise ensembling outputs from the plurality of trained models by computing a weighted average of the outputs of the plurality of trained models. The training data examples may be given the trustworthiness scores by scoring the respective training data example based on the trustworthiness of the user that generated the respective training data example.

A system for introducing user trustworthiness in implicit feedback based machine learning, in one aspect, may comprise a memory operable to store training data examples. One or more processors may be operable to score the training data examples individually based on trustworthiness of users associated respectively with the training data examples, wherein a training data example of the training data examples is given a trustworthiness score. The one or more processors may be further operable to sample the training data examples into a plurality of samples based on a weighted bootstrap sampling technique that samples the training data examples with probability proportional to the trustworthiness of users, a sample comprising one or more of the training examples. The one or more processors may be further operable to run a supervised machine learning algorithm with the samples as input training data. The supervised machine learning algorithm generates a trained model corresponding to each of the plurality of samples, wherein a plurality of trained models is produced. The one or more processors may be further operable to ensemble outputs from the plurality of trained models by computing a weighted average of the outputs of the plurality of trained models.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a flow diagram illustrating an algorithm for introducing user trustworthiness in implicit feedback based machine learning, e.g., implicit feedback based search result ranking or supervised machine learning, in one embodiment of the present disclosure.

FIG. 2 is a diagram illustrating an algorithm for introducing user trustworthiness in machine learning in one embodiment of the present disclosure.

FIG. 3 is a diagram illustrating weighted bootstrap sampling in one embodiment of the present disclosure.

FIGS. 4A and 4B are diagrams that illustrate an implicit feedback example in search engine result rankings.

FIG. 5 illustrates a schematic of an example computer or processing system that may implement a system of introducing user trustworthiness in implicit feedback based search result ranking or in supervised learning one embodiment of the present disclosure.

FIG. 6 shows an example evaluation computation.

### DETAILED DESCRIPTION

In the present disclosure, variations of reliability of user feedbacks are taken into account in training a ranking algorithm in a search engine, a machine learning algorithm. An embodiment of a methodology of the present disclosure, may measure user trustworthiness based on their business metrics data, then use a sampling algorithm to fold the measured user trustworthiness into the ranking algorithm training. Such trustworthiness is also taken into account when evaluating the ranking algorithm. At run-time, the ranking may be generated based on an ensemble of the trained algorithms.

Briefly, a search engine refers to a computer-implemented system or software that searches for information, for example, based on a search query. For example, a web search engine may search for information on the World Wide Web. A user or an agent refers to an entity that interacts with the search engine, for example, inputs one or more queries for search, selects or clicks on one or more search results returned by the search engine, e.g., on a search result page, spends time on pages for example to view the results, and performs other actions.

In another aspect, computed or measured trustworthiness may be used in supervised machine learning system. In another aspect, trustworthiness can be computed based on user profile and business performance metrics, and trustworthiness may be dynamically adjusted. Operating metrics associated with users may be collected to compute user trustworthiness. In yet another aspect, the computed or measured trustworthiness may be used to create sample of training data. In further aspect, weighted sampling may be leveraged for creating multiple samples to train multiple machine learning instances.

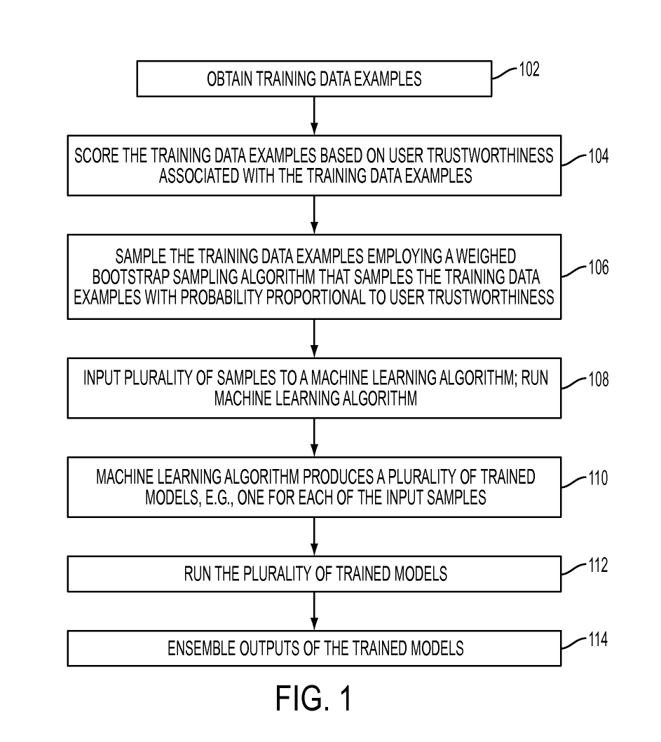

In one embodiment of the present disclosure, one or more methods may be provided that automatically tune a search engine's ranking formula, for example, by learning from agents' searching interactions with the search engine and taking agents' trustworthiness into consideration. FIG. 1 is a flow diagram illustrating an algorithm for introducing user trustworthiness in implicit feedback based machine learning, e.g., implicit feedback based search result ranking or supervised machine learning, in one embodiment of the present disclosure. For example, a search engine in one embodiment of the present disclosure may employ a machine learning technique to learn from implicit feedback of a user, taking into account that user's trustworthiness, e.g., as related to the particular feedback. At 102, training data examples are obtained. Such training data examples may include implicit feedback observed from user interactions with search results, e.g., user selections or click-through data, skipped documents and/or other user behavior with respect to the search results, e.g., obtained from click-through logs. Other examples of implicit feedback may comprise eye movement, e.g., detected by a sensor device and algorithm installed on the device with which the user is interacting.

In a closed domain such as a call center operated by a company, the identity of the user issuing search queries, and the manner in which the search results are applied to specific tasks, can both be analyzed. In such environments, specializations to the implicit feedback method can be made that are not possible in open-ended search systems as provided by search engines available publicly on the World Wide Web or the Internet, from different search engine providers. Firstly, a notion of trustworthiness (which is a complex combination of experience level, skill, and other attributes) of a user of the search system can be measured through attributes that the company can track on a regular basis. Secondly, the search system is queried in order to solve a problem reported by a customer, and the results returned by the search system, if of good quality, is used to solve the customer problem, and regardless of search quality, the solution as well as the problem is recorded in a problem ticket. Analysis of the problem ticket through text and natural language processing techniques that are current state of the art can be used to assess which of the search results, zero, one or many, were used to provide the answer documented in the problem ticket. If such analysis can identify the search results used to provide the solution with a certain degree of confidence, then the base level of implicit feedback that includes identifying search results actually used (clicked on, etc.) can be further refined to produce more accurate training data—identifying the subset of the search results clicked which were relevant—to the core machine learning algorithms. Note that if the subset cannot be determined by analyzing the problem ticket, then the system may default to using only the click-through data.

At 104, the training data examples are weighted or scored based on user trustworthiness associated with the training data examples. For instance, feedback data from a user with higher trustworthiness may be given more weight or score higher than feedback data from a user with lower trustworthiness.

At 106, the training data examples are sampled employing a weighted bootstrap sampling algorithm that samples the training data examples with probability proportional to user trustworthiness. As a specific example, the raw trustworthiness scores of users, i.e., the measurements computed from users' degree of knowledge and/or experience, are normalized so that they add up to 1. Then in the sampling procedure, these normalized trustworthiness scores become the probability of obtaining the data examples from the corresponding users. In this way, for example, more examples from trusted users may be selected by the weighted bootstrap sampling algorithm than from non-trusted users. A number of bootstrap samples may be obtained. For example, multiple samples are produced using the weighted bootstrap sampling algorithm. Each sample contains a subset of the training data examples, e.g., a sample contains one or more of the training data examples. A sample may contain duplicates or multiples of the same example in the training data example.

At 108, the plurality of samples is input to a machine learning algorithm and the algorithm is run for each of the samples. For instance, a machine learning algorithm is run using a sample to train a model. This is done for each of the samples. One example of a machine learning algorithm is the Support Vector Machine (SVM).

At 110, the machine learning algorithm produces or generates a plurality of trained models corresponding to the plurality of samples respectively, e.g., one trained model corresponding to an input sample. A trained model, e.g., is a mathematical model or formula with parameters set or defined according to information learned from the samples.

The trained models output results. For example, in search engine result ranking, the trained models produce ranking results. For instance, search results of a search engine may be input to the trained model, and the trained model is run, e.g., as shown at 112. The trained model outputs the search results in ranking order. Each train model thus may produce a set of rankings.

At 114, the outputs from the trained models are ensembled by computing a weighted average of the outputs to produce a result. If the trained models are rankers, the result would be a ranking result.

The above-described methodology may find applicability in supervised machine learning, in which trustworthiness may be used to weigh the selection of labeled data for training.

The methodology shown in FIG. 1 may be executed on a computer, e.g., by one or more processors, which may include one or more central processing units or specialized hardware processors. A memory device may be connected to the one or more processors and store the plurality of samples, the plurality of trained models, and other data used by the one or more processors.

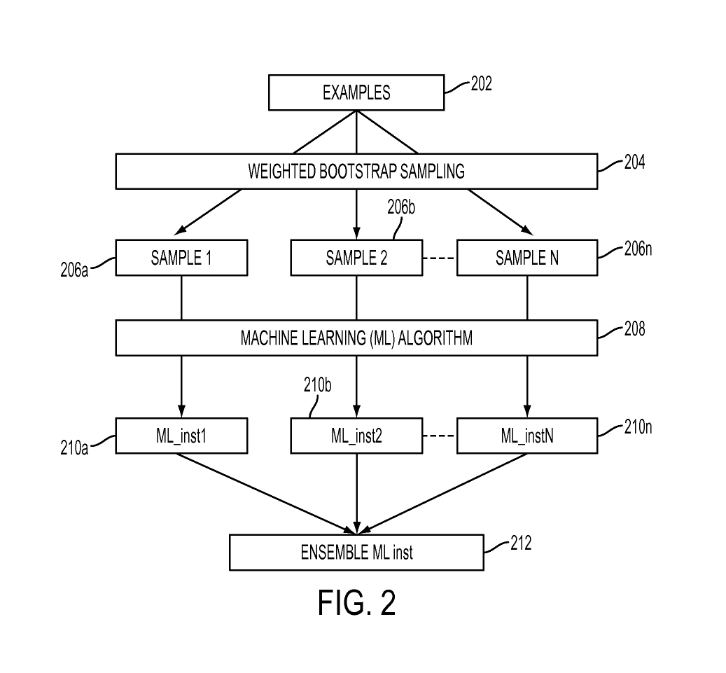

FIG. 2 is a diagram illustrating components of an algorithm for introducing user trustworthiness in machine learning in one embodiment of the present disclosure. Training data, shown as examples 202, which have associated trustworthiness scores, are input to a sampling algorithm, e.g., a weighted bootstrap sampling 204. The sampling 204 picks more examples from trusted users than non-trusted users and outputs the selected examples as samples 206a, 206b, . . . , 206n. For instance, the weighted bootstrap sampling picks more examples that have higher weight or score of trustworthiness as samples. The samples 206a, 206b, . . . , 206n are input to a machine learning algorithm 208. Each sample is a subset of the examples 202. The machine learning algorithm 208 outputs trained models 210a, 210b, . . . , 210n. For example, sample 1 206a is input to the machine learning algorithm 208, which produces a trained model 210a; sample 2 206b is input to the machine learning algorithm 208, which produces a trained model 210b; sample 3 206n is input to the machine learning algorithm 208, which produces a trained model 210n.

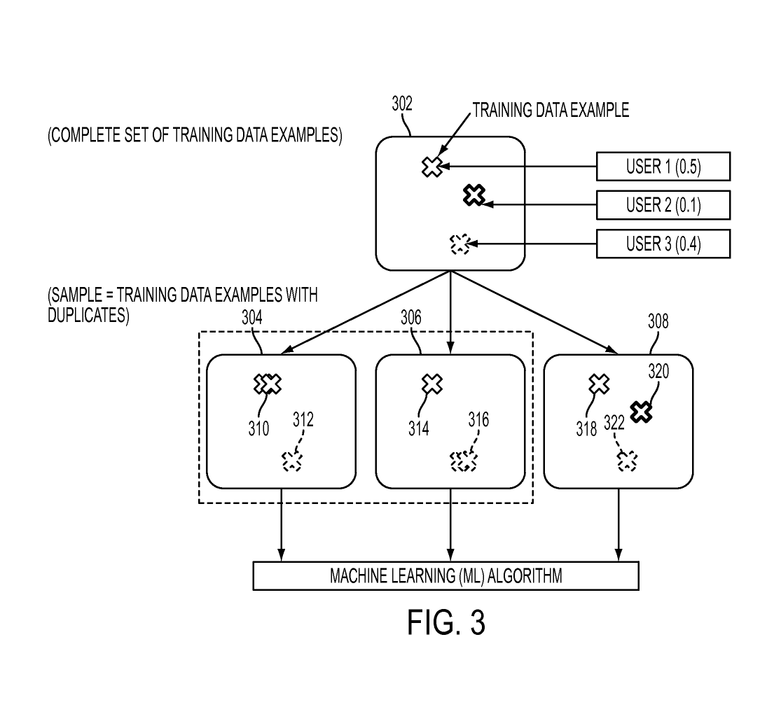

In one aspect, not all training data is used for any given instance of the machine learning (ML) algorithm. For example, referring to the example shown in FIG. 3, in sample 306, the example of user 2 is not included. In one aspect, multiple instances may be used. For instance, again referring to the example shown in FIG. 3, in sample 304, the example of user 1 is duplicated.

The output of the trained models 210a, 210b, . . . , 210n are ensembled to produce an ensembled output 212. For instance, trained model 210a may be run using test data (also referred to as new data), e.g., data not seen before, e.g., to provide a prediction or result as related to the test data. Similarly, trained model 210b may be run using the new data. Likewise trained model 210n may be run using the new data. Each of the trained models 210a, 210b, . . . , 210n produces output with respect to the new data. The outputs from the trained models 210a, 210b, . . . , 210n, are ensembled to produce an ensemble output.

In implicit feedback application of the methodology of the present disclosure, machine learning instance (trained model) 210a, 210b, . . . , 210n may be a ranker. In supervised machine learning application of the methodology of the present disclosure, a machine learning instance (trained model) 210a, 210b, . . . , 210n may be a classifier. One or more of the machine instances 210a, 210b, . . . , 210n may have identical models. In one embodiment, ensemble 212 computes the weighted average of the output of the machine learning instances 210a, 210b, . . . , 210n to account for model duplication.

FIG. 3 is a diagram illustrating weighted bootstrap sampling in one embodiment of the present disclosure. Training data 302 may includes data (e.g., feedback data) from a plurality of different users, e.g., user 1, user 2, user 3. For instance, training data example at 302 includes a set of training data examples from which a plurality of sample sets are chosen. Samples are selected from this training data 302. For instance, sample 1 (304) may include two of user 1 data (shown at 310) and one of user 3 data (shown at 312). Sample 2 (306) may include one of user 1 data (shown at 314) and two of user 3 data (shown at 316). In the example shown in FIG. 3, sample 1 304 and sample 2 306 have training data examples with duplicates. Sample 3 (308) may include one of user 1 data (shown at 318), one of user 2 data (shown at 320) and one of user 3 data (shown at 322). A machine learning algorithm is run with a sample. Each sample produces a trained model. If the machine learning algorithm used is Support Vector Machine (SVM), sample 1 (304) and sample 2 (306) training sets would generate identical models, because for the two training sets (304 and 306), the separating hyper-planes are identical. Briefly, for the hyper-planes of two SVMs to be identical, their support vectors have to be the same. Each support vector is a point in an n-dimensional space. The n dimensions are the independent variables (predictors) of the model.

Briefly, a ranking SVM for implicit feedback may pair clicked (or selected) documents in a search result list with those before it (the skipped ones), e.g., each clicked documents can be paired with a document before it that is not clicked. Such technique relies on relative relevance of top search results.

An example of an ensemble method or algorithm at 114 in FIG. 1 may include a weighted averaging for implicit feedback application, e.g., used in ranking algorithm for ranking search results. Table 1 shows an example that explains a weighted averaging for implicit feedback in one embodiment of the present disclosure. Using the example shown in FIG. 3, the number of training sets (bootstrap samples weighted by trustworthiness) in the example is three (e.g., sample at 304, sample at 306, sample at 308). Two of the three ranking SVM models are identical (produced from sample 1 304 and sample 2 306). Thus, at runtime, output of ranker 1 (ranker 1 generated or trained from using sample 1 and also generated or trained from using sample 2 by the SVM machine learning technique) has twice the weight of ranker 2 (generated or trained from using sample 3 by the SVM machine learning technique).

TABLE 1

| | Normalized | Rank of | Rank of | Rank of |
|---|---|---|---|---|
| | count | document 1 | document 2 | document 3 |
| Ranker 1 | 2/3 | 1 | 2 | 3 |
| Ranker 2 | 1/3 | 1 | 3 | 2 |
| Ensemble | | (2/3) × 1 + | (2/3) × 2 + | (2/3) × 3 + |
| ranker | | (1/3) × 1 = | (1/3) × 3 = | (1/3) × 2 = |
| | | 1 | 7/3 | 8/3 |

Document 1, document 2, and document 3 represent test data. The first row of Table 1 shows that ranker 1 ranked document 1 as first, document 2 as second, and document 3 as third in the search result ranking. The second row of Table 1 shows that ranker 2 ranked document 1 as first, document 2 as third, and document 3 as second in the search result ranking. The third row of Table 1 shows an ensemble ranker that uses weighted average technique. More weight is given to ranker 1 because two samples (sample 1 and sample 2) produced ranker 1 as compared to ranker 2 produced from one sample (sample 3). In this example, the ensemble ranking produces, document 1 as ranked first, document 2 ranked as 7/3th, and document 3 ranked as 8/3.

As described above, a methodology of the present disclosure may also be applicable in supervised machine learning. An example ensemble method (e.g., FIG. 1 at 114) for supervised machine learning may also utilize weighted averaging. Table 2 shows an example that explains a weighted averaging for supervised machine learning in one embodiment of the present disclosure. Supervised machine learning may output classifiers. As input to a supervised machine learning algorithm, consider the same training example shown in FIG. 3, to produce a set of classifiers. Consider as an example that each classifier (built according to a machine learning algorithm using bootstrap weighted sample data) classifies test data into either “Class 0” or “Class 1” with a confidence score ranging from 0 to 1. Assume 0 confidence means prediction is not possible. An example formula for an ensemble classifier may comprise:

T=sum(normalized count*confidence*(1 if prediction is positive; −1 otherwise));

Ensemble prediction=1 if T>0; 0 otherwise;
Ensemble confidence=abs(T).
Normalized count in the above formula, e.g., may be a number of identical (or substantially identical) trained models divided by the total number of trained models.

TABLE 2

| | | Class/ | Class/ |
|---|---|---|---|
| | Normalized | Confidence | Confidence |
| | count | level of input 1 | level of input 2 |
| Classifier 1 | 2/3 | 1/0.8 | 1/0.2 |
| Classifier 2 | 1/3 | 1/0.5 | 0/0.7 |
| Ensemble | | [ (2/3) × 0.8 + | [ (2/3) × 0.2 − |
| classifier | | (1/3) × 0.5 ] = | (1/3) × 0.7 ] = |
| | | 1/0.7 | 0/0.1 |

In the example shown in Table 2, examples of input 1 and input 2 may include an n-dimensional feature vector created from a search result to be classified into class 0 or class 1. The ensemble classifier computes a weighted sum of the results from multiple classifiers (e.g., classifier 1 and classifier 2). In the above example, for input 2, the weighted sum includes subtracting the weighted result of classifier 0 from the weighted result of classifier 1 to compute the class and confidence level.

As described above and for example shown at FIG. 1 at 104, user trustworthiness may be incorporated into training data for producing trained models by weighting or scoring the training data examples with user trustworthiness scores. Such trustworthiness may be computed or obtained from a variety of factors such as the degree of user's knowledge and/or experience associated with training example data. For example, a user's profile metrics may be computed, e.g., normalized to number between 0 and 1, using information about the user: for example, by consulting a company directory to measure years of service, e.g., count years (length of time) spent in role as service agent; checking education records, e.g., count classes taken relevant to job as service agent. As another example of information used to compute user trustworthiness, business metrics may be computed, e.g., normalized to number between 0 and 1 based on information such as: count of cases handled, with no repeat or wrong parts (if applicable); count of cases handled with repeat or wrong part; measure of average handling time per case; measure of survey results of cases handled by this agent (user). For example, consider a service agent in a call center taking calls from customers and suggesting solutions to resolve customer issues. If the suggested solution could not resolve a customer's issue, the customer has to call back to seek further help, which is referred to as a repeat call. Therefore, in this example, the number of repeat calls is an important measurement of an agent's performance. A weighted score combining all metrics, e.g., as described above may be computed. For example, agent 1 handling 1000 cases, 600 with repeat is worse than Agent 2 handling 100 cases with 2 repeats. So in this example, a percentage of repeats may be considered an important derived metrics. A weighting factor may also account for recency; e.g., Agent 1 and 2 both have 40% repeat calls. But Agent 1 had no repeat calls in the last 2 years, while Agent 2 had many repeat calls in the last 2 years.

Recursive definition of trustworthiness score may be given by:

Tᵢ=(1−c)×Tᵢ₋₁+c×Bᵢ;T₀=P, wherein

Tᵢ: trustworthiness score of year i;
Bᵢ: overall business metrics measure of year i;
P: overall profile metrics measure; and
c: weighing factor modeling recency.

A methodology in one embodiment of the present disclosure may provide for weighting based on user trustworthiness measurement, extension of Support Vector Machine (SVM), statistical sampling using trustworthiness, and an ensemble method that ensembles results of multiple trained models.

Machine learning uses features extracted from training data examples to train a model. Take for example a computer-implemented document as a training data example. Such document typically includes fields or attributes such as body, title and tags (e.g., metadata about the document). Features may be extracted from such attributes of the documents and measurements (measures) computed. Example measures may include term frequency (TF), inverse doc frequency (IDF), TFIDF, document length (DL), string kernels, LSA and LSA2, BM25, LMIR.ABS, LMIR.DIR, LMIR.JM. Term frequency (TF) and inverse doc frequency (IDF) refer to statistical weights that represent or measure the importance of a word to a document collection. BM25, LMIR.ABS, LMIR.DIR, LMIR.JM are names of classical retrieval functions. “LMIR” stands for “language model for information retrieval”; “ABS” stands for “Absolute discount”; “DIR” stands for “Dirichlet Prior”; “JM” stands for “Jelinek-Mercer”. Further details can be found in: Chengxiang Zhai and John Lafferty, A study of smoothing methods for language models applied to ad hoc information retrieval, Proceedings of the 24th Annual International ACM SIGIR Conference on Research and Development in Information Retrieval (SIGIR'01), pages 334-342, 2001.

Support Vector Machine (SVM) that may be utilized for search result ranking may extract terms from a search query and features from the search results, for example to perform ranking. For instance, Ranking SVM is a state-of-the art “learning-to-rank” tool that is tailored for implicit feedback. Ranking SVM is based on SVM, a machine learning technique. Ranking SVM may generate feature weights for each sample as ranker. Recall that samples were generated by a weighted bootstrap sampling that generates samples taking into account the user trustworthiness of the training data examples. Sampling may take place off-line, e.g., prior to running the Ranking SVM. Other “learning-to-rank” frameworks may be employed.

As discussed above, a methodology of the present disclosure in one embodiment uses trustworthiness in supervised machine learning systems. In one aspect, trustworthiness can be computed based on user profile and business performance metrics. Trustworthiness may be dynamically adjusted. For example, higher weight may be given to recent experience. Trustworthiness is used to create samples of the training data. Multiple samples and multiple instances are created and the methodology of the present disclosure leverages weighted sampling, for example, for more reliability in results as opposed to using only one sample. Ensemble technique is used to ensemble or aggregate the results from the different samples.

In one embodiment of the present disclosure, the trained models are counted and normalized to weights, e.g., a trained model that has more identical models get more weights. Ensemble technique may aggregate the results from the trained models using the weights, e.g., weighted average of the results, wherein results from trained models that have higher weight are weighed more in the ensemble process.

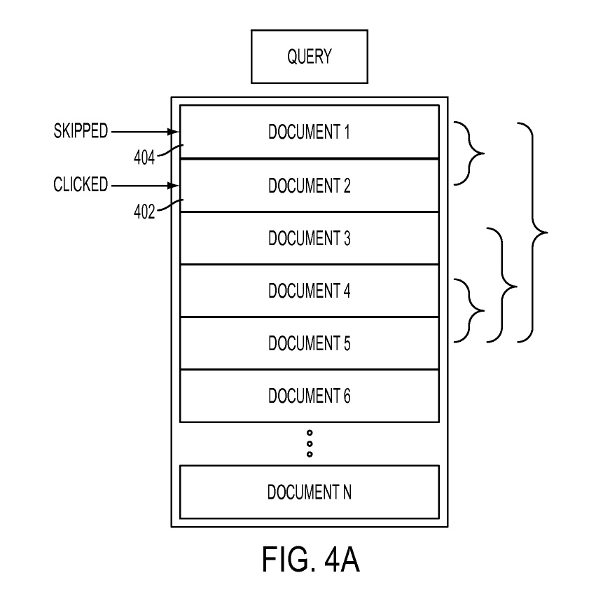

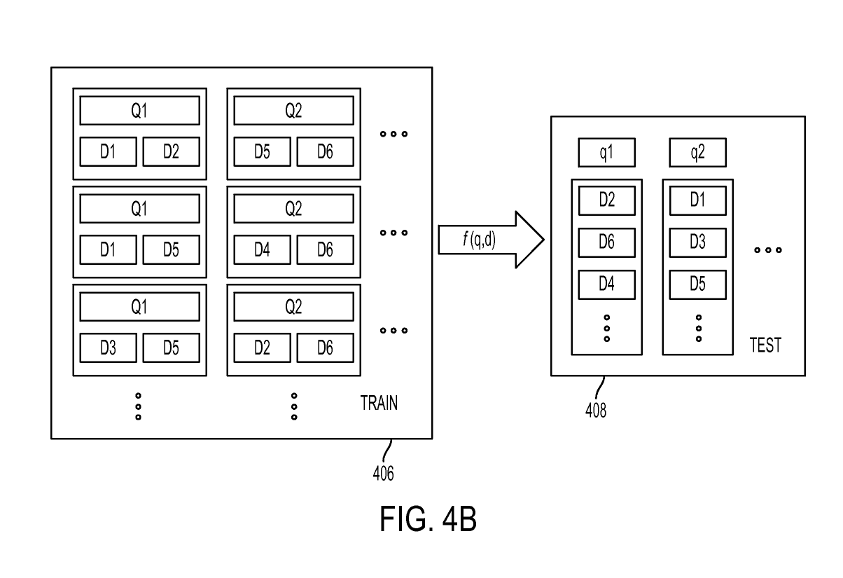

FIGS. 4A and 4B are diagrams that illustrate an implicit feedback example in search engine result rankings. Implicit feedback may be obtained, e.g., from user actions performed on output presented to a user. For instance, consider a search engine outputting a list of search results ranked in the order of relevance to the query as determined by the search engine, e.g., on a user interface display. A user clicking on or selecting one of the results may provide a feedback implicitly to the search engine as to the rankings. For instance, consider that instead of selecting the top-ranked document (e.g., first on the list), the user clicks a second-ranked document (e.g., second on the list). This action may imply that the user preferred the second to the first, e.g., to the user the second document is more relevant to the query than the first document. The search engine through machine learning learns this and may use this feedback to rank the second document before the first document in subsequent search result rankings for the same or similar query. Referring to FIG. 4A that shows an example search result list, each selected or clicked-on document in a list may be paired with a document before it. For example, if the second listed document 402 is selected rather than the first listed documents 404, a pair of normalized values that represent document 1 (404) and document 2 (402) that rank document 2 (402) higher may be generated as training data. FIG. 4B illustrates training data examples 406 and output by machined learning. A pair of documents associated with a query represents a training data example. A plurality of such pairs are used to train a machine learning model For example, for query 1, document 2 has more relevance than document 1, document 5 has more relevance than document 1, document 5 has more relevance than document 3, and so on. For query 2, document 6 has more relevance than document 5, document 6 has more relevance than document 4, document 6 has more relevance than document 2, and so on. In one embodiment of the present disclosure, each of the pairs may also have user trustworthiness associated with it. A sampling algorithm samples a set of the training data pairs based on weighted sampling taking into account the user trustworthiness as weights for example. A trained model may output results of test data (also referred to as new data) shown at 408.

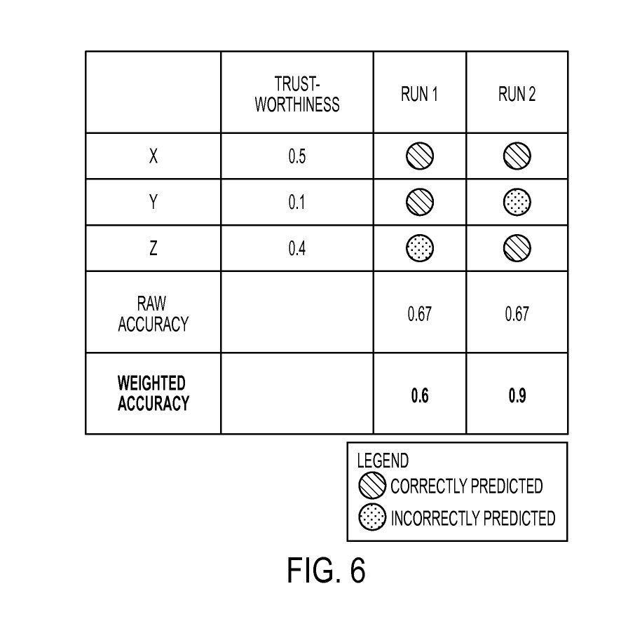

To evaluate the proposed framework, i.e., to measure the accuracy of the output either as compared across different parameter settings or as compared with a baseline method, a novel evaluation scheme is introduced and elaborated as follows. The traditional method for calculating the accuracy is to divide the number of correctly predicted examples by the total number of examples. In contrast, within the proposed evaluation scheme, each example is associated with a weight proportional to its trustworthiness measure, and the weighted accuracy is produced by dividing the total weight of all correctly predicted examples by the total weight of all examples. Such a weighted accuracy serves as a novel type of accuracy measurement for the proposed framework. An embodiment of the methodology of the present disclosure may utilize such evaluation method. FIG. 6 shows an example evaluation computation. In run 1 of one trained model, examples X and Y are correctly predicted, and example Z is incorrectly predicted. In run 2 of another trained model, examples X and Z are correctly predicted, but example Y is mispredicted. The accuracy using traditional method is the same for both runs, which is 0.67. With the proposed evaluation method, run 1 is penalized since the mispredicated example Z has higher trustworthiness score than example Y, which is mispredicated by run 2. Therefore run 1 has a lower accuracy compared to run 2.

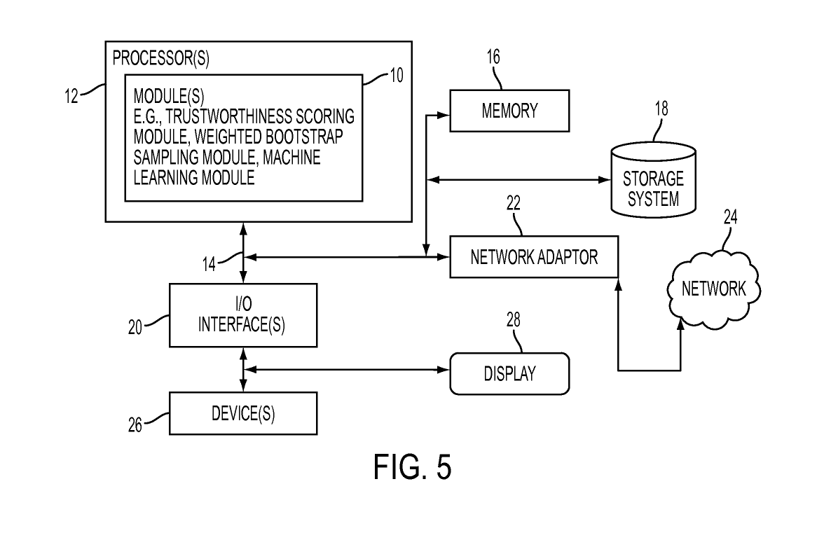

FIG. 5 illustrates a schematic of an example computer or processing system that may implement a system that incorporates user trustworthiness in training data examples used in machine learning to generate trained models in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 5 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include one or more modules 10 that perform the methods described herein. The modules 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method of introducing user trustworthiness in implicit feedback based supervised machine learning systems, comprising:
obtaining training data examples;
scoring, by a processor, the training data examples individually based on trustworthiness of users associated respectively with the training data examples, wherein a training data example of the training data examples is given a trustworthiness score;
sampling, by the processor, the training data examples into a plurality of samples based on a weighted bootstrap sampling technique that samples the training data examples with probability proportional to the trustworthiness of users, a sample comprising one or more of the training examples;
running a supervised machine learning algorithm with the samples as input training data, wherein the supervised machine learning algorithm generates a trained model corresponding to each of the plurality of samples, wherein a plurality of trained models are produced; and
ensembling outputs from the plurality of trained models, by the processor, by computing a weighted average of the outputs of the plurality of trained models.

2. The method of claim 1, wherein the training data is obtained by a search engine log analysis and is further refined by analyzing a document created after search results are returned, in order to determine which subset of the search results selected have been used, the training data refined to contain the subset of the search results.

3. The method of claim 1, wherein the trustworthiness of users is computed by obtaining and combining information comprising business metrics and profile metrics associated respectively with the users.

4. The method of claim 1, wherein the trustworthiness of users is dynamically adjusted based on historical data.

5. The method of claim 1, wherein the sample comprises multiples of a same training data example.

6. The method of claim 1, further comprising running the plurality of the trained models with new data as input to produce said outputs, which are ensembled based on the weights assigned to the trained models.

7. The method of claim 1, further comprising evaluating the trained model by running the trained model using input data having associated trustworthiness scores, and evaluating accuracy of the trained model by taking the associated trustworthiness scores into consideration.

8. A computer readable storage medium storing a program of instructions executable by a machine to perform a method of introducing user trustworthiness in implicit feedback based machine learning, the method comprising:
obtaining training data examples, each of the training data examples given a trustworthiness score based on trustworthiness of a user associated with the respective training data example;
sampling, by the processor, the training data examples into a plurality of samples based on a weighted bootstrap sampling technique that samples the training data examples with probability proportional to associated trustworthiness scores, a sample comprising one or more of the training examples;
running a supervised machine learning algorithm with the samples as input training data, wherein the supervised machine learning algorithm generates a trained model corresponding to each of the plurality of samples, wherein a plurality of trained models are produced;
ensembling outputs from the plurality of trained models, by the processor, by computing a weighted average of the outputs of the plurality of trained models.

9. The computer readable storage medium of claim 8, wherein the training data examples are given the trustworthiness scores by scoring the respective training data example based on the trustworthiness of the user that generated the respective training data example.

10. The computer readable storage medium of claim 8, wherein the trustworthiness of users is computed by obtaining and combining information comprising business metrics and profile metrics associated respectively with the users.

11. The computer readable storage medium of claim 8, wherein the trustworthiness of users is dynamically adjusted based on historical data.

12. The computer readable storage medium of claim 8, wherein a sample comprises multiples of the same training data example.

13. The computer readable storage medium of claim 8, further comprising running the plurality of the trained models with new data as input to produce said outputs.

14. The computer readable storage medium of claim 8, further comprising evaluating the trained model by running the trained model using input data having associated trustworthiness scores, and evaluating accuracy of the trained model by taking the associated trustworthiness scores into consideration.

15. A system for introducing user trustworthiness in implicit feedback based machine learning, comprising:
a memory operable to store training data examples; and
one or more processors operable to score the training data examples individually based on trustworthiness of users associated respectively with the training data examples, wherein a training data example of the training data examples is given a trustworthiness score,
the one or more processors further operable to sample the training data examples into a plurality of samples based on a weighted bootstrap sampling technique that samples the training data examples with probability proportional to the trustworthiness of users, a sample comprising one or more of the training examples,
the one or more processors further operable to run a supervised machine learning algorithm with the samples as input training data, wherein the supervised machine learning algorithm generates a trained model corresponding to each of the plurality of samples, wherein a plurality of trained models are produced,
the one or more processors further operable to ensemble outputs from the plurality of trained models by computing a weighted average of the outputs of the plurality of trained models.

16. The system of claim 15, wherein the trustworthiness of users is computed by obtaining and combining information comprising business metrics and profile metrics associated respectively with the users.

17. The system of claim 15, wherein the trustworthiness of users is dynamically adjusted based on historical data.

18. The system of claim 15, wherein a sample comprises multiples of the same training data example.

19. The system of claim 15, wherein the one or more processors further run the plurality of the trained models with new data as input to produce said outputs.

20. The system of claim 15, wherein the one or more processors further evaluate the trained model by running the trained model using input data having associated trustworthiness scores, and evaluating accuracy of the trained model by taking the associated trustworthiness scores into consideration.
